(19) United States
(12) Patent Application Publication
(10) Pub. No.: US 2006/0126618 A1
(43) Pub. Date: Jun. 15, 2006

(54) System and method for front end processing of messages

(75) Inventors: Leonard K. Pennock, Chandler, AZ (US); Bradley R. Schaefer, Chandler, AZ (US); Daryl E. Straszheim, Gilbert, AZ (US)

Correspondence Address: MOTOROLA, INC., LAW DEPARTMENT, 1303 E. ALGONQUIN ROAD, SCHAUMBURG, IL, 60196, US

(73) Assignee: Motorola, Inc.

(21) Appl. No.: 11/013,012

(22) Filed: Dec. 15, 2004

(51) Int. Cl. H04L 12/56

(52) U.S. Cl. 370/389

(57) ABSTRACT

A system and method of routing messages between at least one server (104, 106, 108) and at least one remote device (114, 116, 118). A message (112) is received from a remote device (116). The remote device has an Internet Protocol (IP) address. The remote IP address is mapped to a server address corresponding to a selected one of a plurality of servers (104, 106, 108).

### FIELD OF THE INVENTION

This invention generally relates to transmitting communications in networks. More specifically, it relates to transmitting communications efficiently within these networks.

### BACKGROUND OF THE INVENTION

The Transport Control Protocol/Internet Protocol (TCP/IP) is a suite of protocols used in Internet applications to route messages between different points in a network. One protocol from the suite is the Transport Control Protocol (TCP) protocol, which is responsible for controlling the movement of information between applications. Other examples of protocols in the suite include the User Datagram Protocol (UDP) and the Internet Protocol (IP).

As mentioned above, the TCP protocol specifies procedures for the exchange of data between applications such as between a remote client and a server. Before sending data from a server and a remote host using the TCP protocol, a TCP connection must first be established. In order to establish the connection, messages are exchanged between the server and the remote host. These may include synchronization (SYN) and acknowledgement (ACK) messages. Once the connection is established, data can be exchanged between the server and the remote host.

In previous systems, the client was unaware of the existence of multiple servers and a single IP address maps to a single entity. Since the same IP address corresponds to all possible destinations, an intermediate entity is typically used to distinguish between destinations and route the message to the appropriate destination. In many previous systems, a front end processor (FEP) is situated between the remote clients and the servers to modify the IP address in the packet so that the packet can be routed to the correct destination server.

Unfortunately, several problems occur in these previous systems because of the need to modify the contents of the packet at the front end processor. For instance, because the difficulty of performing the actions at the front end processor, line rates were limited. In addition, a time-consuming reassembly of the packets is required and the FEP needed to be aware of the application involved. Previous approaches also often require application-specific processing to process the IP addresses that are embedded in the IP packets as the packets are disassembled. Also, once encryption was used, it was difficult for the FEP to be able to modify the contents of the packets. All of these considerations may significantly increase the cost of the system and contribute to a slow-down in the processing of packets in the system.

### BRIEF DESCRIPTION OF THE DRAWINGS

FIG. 1 is a block diagram showing a system for routing messages using a front end processor according to various embodiments of the present invention;

FIG. 2 is a block diagram showing a system one example of a front end processor according to various embodiments of the present invention;

FIG. 3 is a block diagram showing one example of an approach for routing messages using a front end processor according to various embodiments of the present invention; and

FIG. 4 is a block diagram showing one example of a mapping relationship used by a front end processor to route messages according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system for automatically routing a message from a remote client to a server without modifying the contents of the message uses a front end processor to perform the routing. The front end processor utilizes a mapping relationship to translate a message identifier into an identifier corresponding to a particular destination server or servers. In this way, packets are quickly routed to a destination server without having to disassemble or modify the packets.

In many of these embodiments, messages are routed between one or more servers and a remote device. A message is received from the remote device at the front end processor. In one example, the remote device may have a remote Internet Protocol (IP) address that is included in the message. This remote IP server address is mapped to an address corresponding to a selected one of the servers. The message can then be routed to one (or more) of the servers using the server address. By using this approach, the packet and its contents remain unmodified.

The mapping of the remote IP address may map the IP address to a physical port number of the selected one of the plurality of servers. The packet may have a Layer 3 (L3) IP address. Other types of addressing schemes may also be used.

Thus, the present approaches avoid modifying the message or its contents. In these approaches, the message is quickly and efficiently mapped to a destination server or servers. The source of the message need not modify the message in any way since the front end processor performs all mapping and routing functions. Consequently, the time to route a message from a source to a destination is significantly reduced.

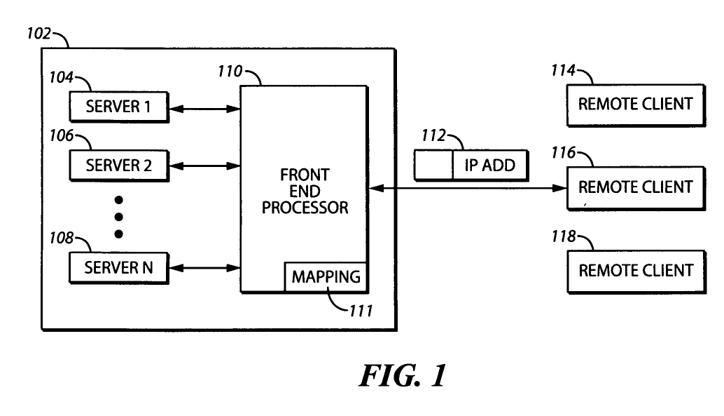

Referring now to FIG. 1, a server arrangement/box 102 includes a first server 104, second server 106, and an nth server 108. The servers 104, 106, and 108 are coupled to a front end processor 110. The front end processor 110 stores a mapping relationship 111. The mapping relationship 111 may be stored in a memory device at the front end processor 110. The depicted remote clients 114, 116, and 118 are coupled to the front end processor 110 of the server arrangement 102.

The servers 104, 106, and 108 comprise processor boards that manage and process messages according to programmed criteria. The servers 104, 106, and 108 may be identical or they may process the messages differently according to, for example, the type of message received or the source of the message.

The front end processor 110 may include any type of controller that processes ingress messages (i.e., messages received from the remote clients 114, 116, or 118) and egress messages (i.e., messages sent from one of the servers 104, 106, and 108 to one of the remote clients 114, 116, or 118). Communications between the server arrangement 102 and the remote clients 114, 116, and 118 is performed according to the TCP/IP protocols.

The remote clients 114, 116, and 118 may represent any number of applications or services. For example, the remote clients 114, 116, and 118 may be other servers and/or supply various types of services for the system.

In one example of the operation of the system shown in FIG. 1, messages are exchanged between the servers 104, 106, and 108 and the remote clients 114, 116, and 118. For instance, one remote client 116 may determine to send a message 112 to one of the servers 104, 106 or 108. In this case, a TCP connection request is passed through to a server based upon mapping criteria. The message 112, including an IP address, is formed at the remote client 116 and sent to the front end processor 110. The front end processor 110 receives the message 112. The front end processor 110 extracts the IP address from the message 112. Using the mapping relationship 111, the IP address in the message 112 is then mapped and/or converted into a destination address (or other identifier) of one or more of the servers, for example, a port number. The mapping relationship 111 may also map the IP address to more than one server address as well.

The mapping relationship 111 may be any number of procedures and/or data structures that identify a destination server or servers based upon an identifier in the message. For example, the mapping relationship 111 may be a table that maps a range of addresses into a destination port number. An example of such a table is described with respect to FIG. 4 described elsewhere in this application. The mapping relationship 111 may also be an equation or a combination of an equation and data structure. Other examples of routing relationships are possible.

After the mapping relationship 111 is used to determine the identity of the destination server 104, 106, or 108, the message 112 is routed to the appropriate server. The IP address and the remaining contents of the message 112 are not changed or modified by the processing and routing performed at the front end processor 110. Consequently, the source of the message (i.e., remote client 116) only needs to know the IP address of the servers and does not need to know the detailed routing relationship between the source and the destination.

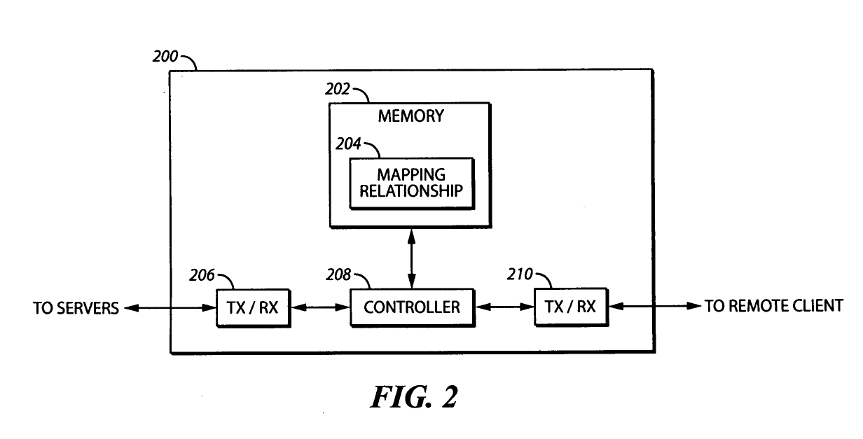

Referring now to FIG. 2, one example of a front end processor 200 is described. The front end processor 200 includes a memory 202, a controller 208, and first and second receiver/transmitters 206 and 210. The memory 202 stores a mapping relationship 204.

In the ingress direction (from remote client to server), the receiver/transmitter 210 receives a message, for instance, a data packet. The receiver/transmitter 210 examines the message for an identifier to indicate the destination of the message. In one example, the identifier may be an IP address. The controller 208 then retrieves the mapping relationship 204 that is stored in the memory 202 and applies it to the identifier. The result of the application is a destination identifier. For example, the destination identifier may be a port number of a destination server. The receiver/transmitter 206 is then used to transmit the message to the correct destination server. As described above, the contents of the message are preferably not modified or altered in any way.

In the egress direction (from server to remote client), the receiver/transmitter 206 receives a message. The message has an identifier that specifies the destination of the message. The controller 208 obtains the message and, since the message is an egress message, does not apply the mapping relationship 204 to the message. The message is sent to the receiver/transmitter 210 where it is forwarded to the appropriate destination, in this case, one (or more) of the client servers. Again, the contents of the message are not modified by the front end processor 200.

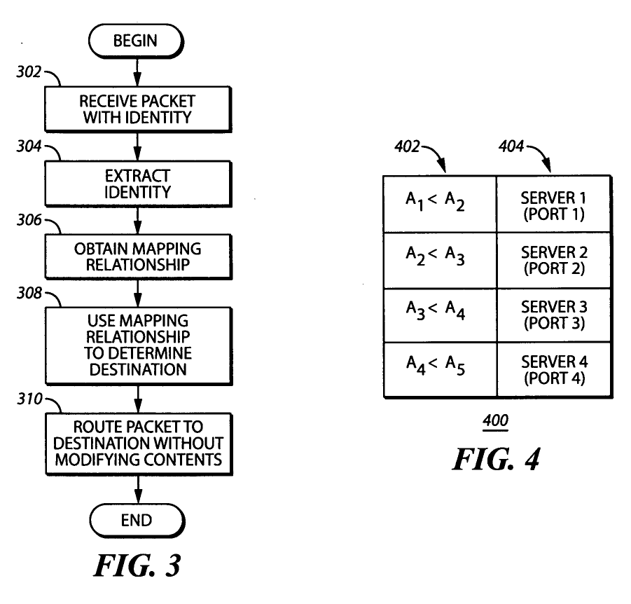

Referring now to FIG. 3, one example of an approach to route messages using a front end processor is described. At step 302, the front end processor receives a message, for example, a data packet. The message includes an identifier that identifies the destination of the message. For example, the identifier may be an IP address. At step 304, the front end processor extracts the identifier from the message. For example, the front end processor may use any available extraction program or routine to identify where in the packet the identifier is located and obtain the identifier. Once obtained, the identifier may be stored in a temporary memory location.

At step 306, the front end processor obtains a mapping relationship from a memory. Numerous examples of mapping relationships are possible. For example, as described below with respect to FIG. 4, the mapping relationship may be a table where certain ranges of addresses may correspond to certain destination servers. In another example, the mapping relationship may be an equation. In this case, the equation is applied to the identifier and the result of the application is the identity of the destination server. In still another example of a mapping relationship, a combination of an equation and data structure may be used to determine the identity of the destination server. Other examples of routing relationships are possible.

At step 308, the front end processor applies the mapping relationship to the identifier to obtain the identity of the destination server. In one example, an IP address is applied to a lookup table and the result of the application gives a physical port number of the destination server. In another approach, a Layer 2 (L2) address may be used to choose the correct server while not modifying the Layer 3 (L3) address. At step 310, the packet is routed to the destination server using the identity that was determined using the mapping relationship.

Referring now to FIG. 4, one example of a mapping relationship is described. In this case, the mapping relationship is a lookup table 400. The lookup table 400 can be stored in a memory. The lookup table has a first column 402, which represents an address range. For example, the first entry is for addresses between A1 and A2; the second for addresses between A2 and A3; the third for address between A3 and A4; and the fourth for addresses between A4 and A5.

The second column represents the identity of the server that a particular address range maps. For example, addresses between A1 and A2 map to port 1; addresses between A2 and A3 map to port 2; addresses between A3 and A4 map to port 3; and the addresses between A4 and A5 map to port 4. A controller in the front end processor obtains the table 400 from memory and uses the table to identify a port number or port numbers that correspond to an IP address.

Thus, modification of messages and/or their contents is avoided by the front end processor. The message, for example, the data packet, is quickly and efficiently mapped to a destination server or servers. Since the source of the message need take no actions or modify the message, the time needed to route a message from a source client to a destination server is significantly reduced.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of routing messages between at least one server and at least one remote device comprising:
receiving a message from a remote device, the remote device having a remote Internet Protocol (IP) address; and
mapping the remote IP address to a server corresponding to a selected one of a plurality of servers.

2. The method of claim 1 further comprising routing the message to the selected one of the plurality of servers using the same server address.

3. The method of claim 1 wherein the mapping of the remote IP address comprises mapping the IP address to a physical port number of the selected one of the plurality of servers on a front end processor (FEP).

4. The method of claim 1 further comprising receiving a data packet from the selected one of the plurality of servers and sending the data packet to the remote device without modifying the data packet.

5. The method of claim 1 further comprising routing the message to the selected one of the plurality of servers using the server address without modifying the message.

6. The method of claim 1 wherein receiving the message from a remote device comprises receiving a packet having a Layer 3 (L3) IP address.

7. A front end processor for connecting a remote device to a server comprising:
a memory having a mapping relationship stored therein;
a receiver having an input line that receives a packet having a source Internet Protocol (IP) address on the input line;
a controller coupled to the memory and the input line of the receiver and programmed to determine a destination server using the mapping relationship and source IP address of the packet.

8. The front end processor of claim 7 wherein the source IP address is a Layer 3 (L3) IP address.

9. The front end processor of claim 7 further comprising a transmitter coupled to the controller and having an output and wherein the processor is programmed to transmit a message on the output to a remote address without modifying the message.

10. A method of routing packets from a remote device to a selected one of a plurality of servers comprising:
receiving a data packet from the remote device, the data packet having a source identifier;
extracting and identifying the source identifier from the data packet;
storing a mapping relationship in a memory;
mapping the source identifier into a destination identifier using the mapping relationship; and
routing the packet to a server associated with the destination identifier.

11. The method of claim 10 wherein receiving the packet from the remote device comprises receiving a packet having a Layer 3 (L3) IP address.

12. The method claim 10 wherein mapping the source identifier comprises mapping the source identifier to a physical port address.

13. The method of claim 10 further comprising transmitting a data packet from a server to the source device without modifying the packet.

14. The method of claim 10 wherein routing the packet to the server comprises routing the packet to the server without modifying the packet.
